(19) United States
(12) Patent Application Publication
(10) Pub. No.: US 2005/0047439 A1
(43) Pub. Date: Mar. 3, 2005

(54) System to process packets according to an assigned sequence number

(76) Inventor: Tomasz Bogdan Madajczak, Gdansk (PL)

Correspondence Address: BUCKLEY, MASCHOFF, TALWALKAR LLC, 5 ELM STREET, NEW CANAAN, CT, 06840, US

(21) Appl. No.: 10/647,984

(22) Filed: Aug. 26, 2003

(51) Int. Cl. H04J 3/16

(52) U.S. Cl. 370/469; 370/473; 370/474

(57) ABSTRACT

According to some embodiments, a portion of a network packet is received, a sequence number is retrieved, a sequence number is passed to a sequence election unit, a signal to process the packet is received from the sequence election unit, and processing is performed on the packet in response to receipt of the signal.

### BACKGROUND

Conventional communication networks allow network devices to exchange messages with one another. A message may be transmitted in the form of multiple packets, each of which includes data and header information. Network devices process the header information in order to route the packets to their destination and to properly reassemble the message.

A network device may receive multiple packets of multiple messages. Some network devices currently use multi-threaded processors to process such packets. According to conventional processing, one or more threads of a multi-threaded processor process a first-received packet and one or more threads of the processor then process a next-received packet. This arrangement is intended to ensure that a first packet of a message is processed before a second packet of the message is processed. However, such an arrangement might not provide efficient processing.

### BRIEF DESCRIPTION OF THE DRAWINGS

FIG. 1 is a block diagram of a network according to some embodiments.

FIG. 2 is a block diagram of a network processor according to some embodiments.

FIG. 3 is a flow diagram of a process executed by an execution thread and associated with in-group-order processing according to some embodiments.

FIG. 4 is a timing diagram of in-group-order processing according to some embodiments.

FIG. 5 is a flow diagram of a process executed by a sequence election unit and associated with in-group-order processing according to some embodiments.

FIG. 6 is a diagram of a sequence election unit according to some embodiments.

FIG. 7 is a flow diagram of a process executed by an execution thread and associated with critical section processing according to some embodiments.

FIG. 8 is a timing diagram of critical section processing according to some embodiments.

FIG. 9 is a flow diagram of a process executed by a sequence election unit and associated with critical section processing according to some embodiments.

FIG. 10 is a block diagram of a system according to some embodiments.

### DETAILED DESCRIPTION

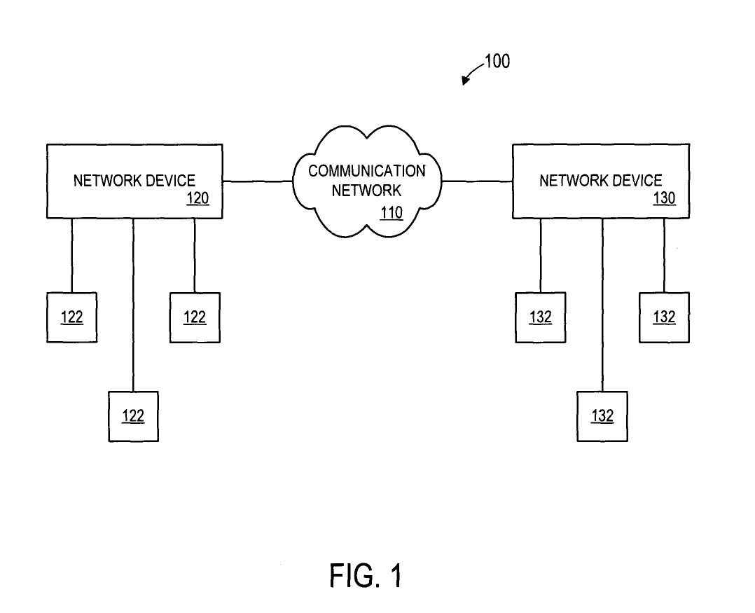

FIG. 1 is a block diagram of communication system 100. Communication system 100 includes communication network 110, which is in communication with network device 120 and network device 130. In particular, network device 120 may exchange information with network device 130 via communication network 110. Network devices 120 and 130 may comprise, for example, network switches or routers, such a device incorporating one or more IXP2400 network processors available from Intel®. A network switch or router may receive streams of data from other network devices, such as personal computers and handheld devices, process the data, and forward the data to appropriate other network devices, including other network switches or routers. The data may be received and forwarded by several network devices until they reach an appropriate destination.

Communication network 110 may comprise one or more network types, including but not limited to a Local Area Network (LAN), a Metropolitan Area Network (MAN), a Wide Area Network (WAN), a Fast Ethernet network, a wireless network, a fiber network, and/or an Internet Protocol (IP) network, such as the Internet, an intranet, or an extranet. Communication network 10 may support Layer 2 protocols, such as Ethernet or Packet-Over SONET, in which data is transmitted in packet form. Moreover, communication network 110 may comprise one or more of any readable medium for transferring data, including coaxial cable, twisted-pair wires, fiber-optics, RF, infrared and the like. Communication network 110 may include any number of unshown network devices (e.g., intermediate switches and routers).

As illustrated in FIG. 1, network device 120 may communicate with a number of associated network devices 122. Each of network devices 122 may comprise any device for communicating via network packets, including a personal computer, a personal digital assistant, a cellular telephone, or the like. Similarly, network device 130 may communicate with a number of associated devices 132. One of devices 122 may thereby transmit a stream of network packets to one of devices 132. The network packets may be encapsulated and transmitted according to any network protocol according to some embodiments.

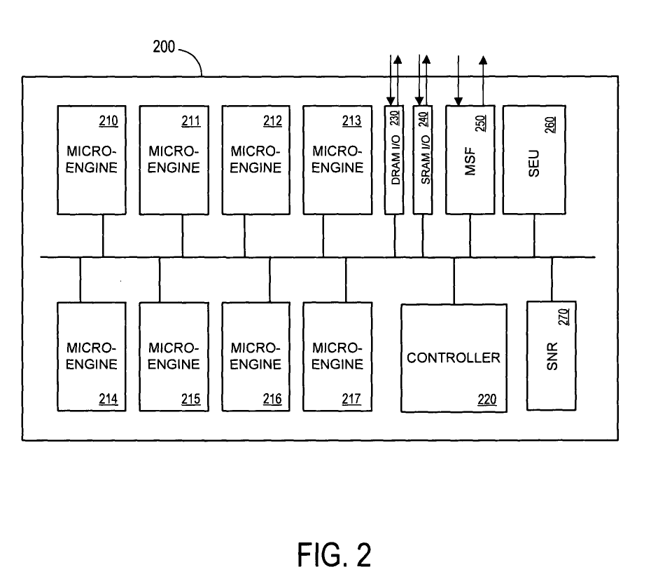

FIG. 2 is a block diagram of network processor 200 that may be used in conjunction with some embodiments. Network processor 200 may comprise the aforementioned IXP2400 Network Processor and may therefore be an element of network device 120. Other processors may be used in some embodiments, such as an IXP2800® Network Processor or a processor provided by another manufacturer.

Network processor 200 includes microengines 210 through 217. Each of microengines 210 through 217 may comprise a packet processing engine. In some embodiments, each of microengines 210 through 217 comprises a multi-threaded Reduced Instruction Set Computing (RISC) processor for processing network packets independently from one another. According to some embodiments, each of microengines 210 through 217 supports up to eight execution threads. The above-mentioned IXP2800 Network Processor may comprise sixteen microengines.

Each of microengines 210 through 217 may comprise a control store to store microcode including function calls that are executable by a respective microengine. A group of function calls used to perform particular packet processing is a microblock. The packet processing may include any type of processing, such as packet receiving, IPv6 forwarding, MPLS forwarding, and packet classification.

Each of microengines 210 through 217 may also include a respective local memory. A local memory may comprise 4 Kb of memory for storing 640 long words (32 bits) of data. Local memories may be privately-addressable by their respective microengine and may be used by execution threads for temporary storage during execution of a microblock. Each of microengines 210 through 217 may include additional storage, such as general-purpose and transfer registers.

Network processor 200 also includes Controller 220. Controller 220 may comprise, for example, a control plane processor (e.g., an Intel® XScale™ processor) that performs control and system management functions and executes real-time applications. DRAM I/O 230 receives and transmits information including network packets from and to a remote DRAM, and SRAM I/O 240 performs similar functions with respect to a remote SRAM.

Media and Switch Fabric (MSF) 250 couples processor 200 to a network physical (PHY) layer and/or a switch fabric. MSF 250 includes independent receive and transmit interfaces, as well as a receive buffer. The receive buffer stores incoming packets in buffer sub-blocks known as elements. The receive buffer may store 8 KB of data, and the element size may be set to one of 64 B, 128 B or 256 B.

In operation, MSF 250 may break down a received network packet into multiple packet portions, or m-packets, of the set element size, with each m-packet being stored as a segment within an element of the receive buffer. A Receive Status Word (RSW) register of MSF 250 may include information describing the m-packets stored within its elements.

A thread may receive an indication from MSF 250 that the receive buffer has received a new m-packet. Threads of each microengine may read an element of the receive buffer. In this regard, each thread of a microengine may be associated with its own register set, program counter and thread-specific local registers within the microengine. Such an arrangement may allow a thread of microengine to execute a computation while another thread of the microengine waits for an I/O procedure (e.g. external memory access) to complete or for a signal from another thread or hardware element.

Each thread may be in one of four states: inactive, executing, ready, or sleep. A thread is inactive if it is not to be used by a particular microblock executed by its microengine. An executing thread is in control of its microengine, and the program counter of an executing thread fetches program code to be executed. A thread remains in the executing state until it executes code that causes it to enter the sleep state. According to some embodiments, only one thread of a microengine may be in the executing state at a given time. However, threads of different microengines may simultaneously be in the executing state.

In the ready state, a thread is ready to execute code but is not because another thread is in the executing state. When the executing thread enters the sleep state, a microengine arbiter selects a next thread to enter the executing state from all threads in the ready state. A thread in the sleep state is waiting for an external event to occur. As mentioned above, this event may include completion of an I/O procedure and a signal from a hardware element.

Such a signal may be received from Sequence Election Unit (SEU) 260. In some embodiments, SEU 260 transmits an election signal to an execution thread of one of microengines 210 through 217. The election signal may signal the execution thread to perform particular processing on an m-packet. As will be described in more detail below, such an arrangement may provide in-order group packet processing and/or proper critical section processing within a packet processing pipeline.

SEU 260 may transmit an election signal to an execution thread based on a sequence number associated with the thread. The execution thread may retrieve such a sequence number from Sequence Number Register (SNR) 270. SNR 270 may have a 32-bit capacity and may be accessible by all execution threads of processor 200 as a global Context Status Register. According to some embodiments, SNR 270 stores an internal value, and, in response to a request from an execution thread, transmits the value to the thread and atomically increments the internal value. As a result, the value of a retrieved sequence number will be less than a value of a subsequently-retrieved sequence number. Operation of SEU 260 and SNR 270 in conjunction with some embodiments will be described below.

Network processor 200 may include elements other than those illustrated in FIG. 2. For example, network processor 200 may include elements for communicating with a host processor over a standard PCI interface. Network processor 200 may also or alternatively include a scratchpad memory for quickly passing data between microengines and/or threads.

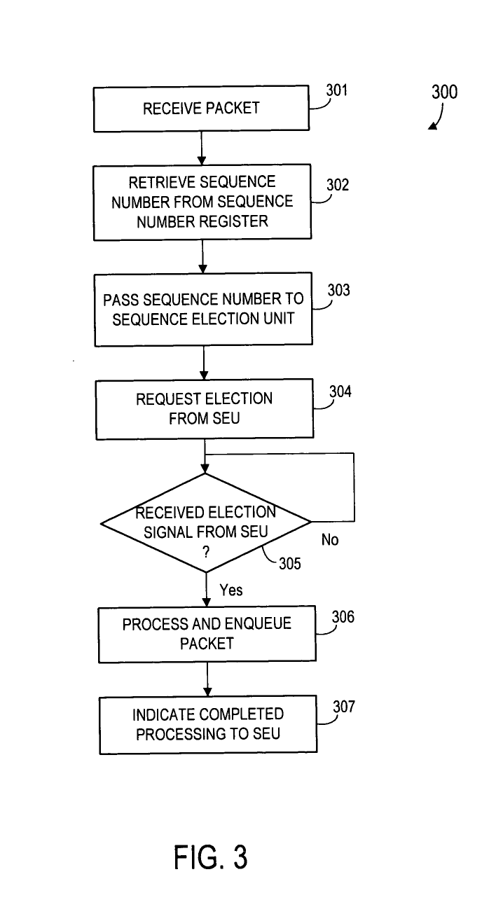

FIG. 3 is a flow diagram of process 300 that may be executed by network device 120 to process a network packet. More particularly, process 300 may be executed by each of a plurality of threads of one or more of microengines 210 through 217 of network processor 200 to perform in-group order processing of network packets. Process 300 may be embodied in program code stored in one of the above-described control stores. The program code may be received by a control store from any medium, such as a hard disk, an IC-based memory, a signal, a network connection, or the like. In this regard, the program code may be included in a Software Developers' Kit associated with network processor 200.

Prior to 301, an m-packet may be analyzed to determine an execution thread that should perform next processing on the m-packet. In some embodiments, the next processing is processing that should be performed in group order. For example, a code designer may specify that voice channel processing is to be performed by specific execution threads of microengines 210 through 217. The specific threads may be associated with a single one of the microengines. The m-packet is dequeued to the determined execution thread from a receive ring prior to 301.

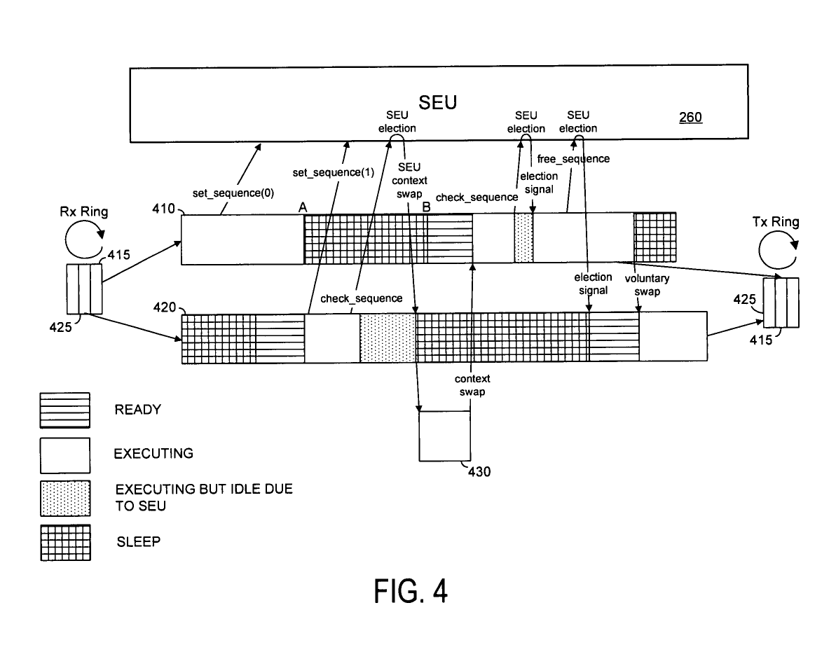

The determined execution thread receives the dequeued m-packet at 301. FIG. 4 illustrates SEU 260 and execution threads 410, 420 and 430 for the purpose of describing one implementation of process 300. As shown, execution thread 410 receives m-packet 415 from the receive ring at 301.

Next, at 302, execution thread 410 retrieves a sequence number from SNR 270. As mentioned above, SNR 270 responds to a request from an execution thread by transmitting a stored value to the thread and atomically incrementing the stored value. Execution thread 410 then passes the sequence number to SEU 260 at 303 as depicted by the arrow labeled “set_sequence(0)”, where 0 is the sequence number.

The sequence number may be passed along with an identifier identifying execution thread 410 and a thread mask. The identifier may be implicit in the set_sequence command, and the thread mask may indicate a group of threads designated to perform particular processing. In one example, the mask may comprise 00001111₂, with each bit representing a single thread. Such a mask may indicate that threads 0 to 3 of a microengine are a group designated to perform particular processing. Threads identified by a mask may include execution threads of different microengines. SEU 260 may store the thread identifier, sequence number and mask in association with one another.

As will be seen below, the mask allows SEU 260 to determine which of a designated group of threads is associated with a lowest sequence number. Such a determination may enable in-group order processing of packets by threads belonging to the group, without regard to processing conducted by threads not belonging to the group. Moreover, a mask may allow a single SEU 260 to control processing order for multiple independent groups of execution threads. Some embodiments utilize multiple instances of SEU 260. Such embodiments may require an execution thread to identify the SEU that is responsible for ordering the particular processing and to pass the sequence number to the identified SEU at 303.

Returning to the FIG. 4, execution thread 420 executes process 300 in parallel with execution thread 410. Specifically, execution thread 420 receives packet 425 from the receive ring at 301 and enters the ready state. However, execution thread 420 does not enter the executing state until time A, at which point execution thread 410 leaves the executing state due to a context-swapping action such as I/O access.

Execution thread 420 then executes 302 and 303 to pass its associated sequence number (1) to SEU 260. SEU 260 may then store the sequence number in association with a thread identifier and a mask. The mask according to the present example is identical to the mask stored in association with thread 410.

At 304, prior to a executing a section of microcode that requires in-group ordering, execution thread 420 requests election from SEU 260. The request is depicted in FIG. 4 by an arrow extending from execution thread 420 to SEU 260 and labeled “check_sequence”. A self-identifier of execution thread 420 may directly or indirectly passed to SEU 260 with the “check_sequence” command to identify itself to SEU 260. Execution thread 420 then pauses at 305 until an election signal is received from SEU 260. As shown, execution thread 420 is idle but remains in the executing state until a context swap caused by SEU 260. SEU 260 causes the context swap because execution thread 420 is not associated with the lowest sequence number of all threads specified by the associated mask. Rather, thread 410, which is associated with the same mask as thread 420, is associated with a lower sequence number (0) than execution thread 420 (1).

The context swap passes the context to thread 430, which executes any appropriate microcode. Thread 430 might not be associated with the mask of thread 410 and thread 420, and may perform a different processing on a different type of m-packet. A context swap occurs due to an I/O access or the like, returning the context to execution thread 410. In this regard, execution thread 410 has entered the ready state at time B after completing whatever process that caused the initial context swap shown in FIG. 4.

Thread 410 requests election from SEU 260 at 304 prior to executing the section of microcode that requires in-group ordering. Thread 410 then idles at 305 but remains in the executing state until an election signal is received from SEU 260. The election signal is received at time C, because execution thread 410 is associated with the lowest sequence number (0) of all threads specified by the associated mask.

Execution thread 410 then proceeds at 306 to process the packet according to the particular processing procedure that requires the in-group ordering. Packet 415 is then enqueued to the transmit ring as shown in FIG. 4, and execution thread 410 indicates completed processing to SEU 260 at 307.

Execution thread 410 may indicate completed processing by passing a “free_sequence” command to SEU 260. SEU 260 then transmits an election signal to execution thread 420 because thread 420 is associated with the next-lowest sequence number of all threads specified by the associated mask. In this regard, thread 420 wakes from its sleep state to the ready state in response to the election signal. Execution thread 410 may then perform a voluntary swap to allow other threads to execute. In the illustrated example, the voluntary swap allows thread 420 to process packet 425 and enqueue packet 425 in the transmit ring. The foregoing process thereby allows a first-received packet to be processed and enqueued before a second-received packet.

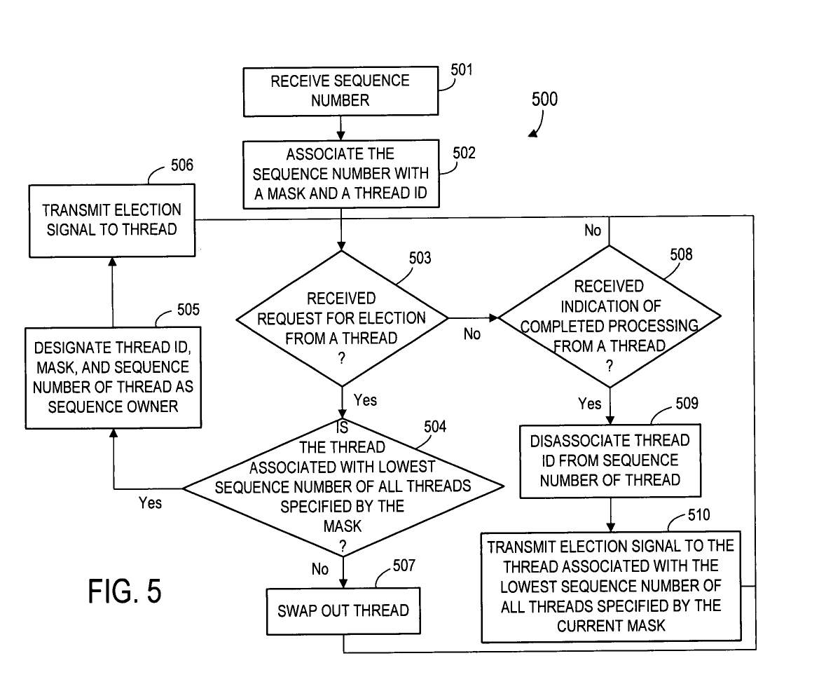

FIG. 5 is a flow diagram of process 500 that also may be executed by network device 120 to process a network packet. Specifically, process 500 may be executed by SEU 260 in conjunction with the execution of process 300 by one or more execution threads. Process 500 may be embodied in program code stored in one of the above-described control stores and/or may be hardware-implemented.

The general operation of process 500 was touched on above with respect to the description of process 300, since process 500 is performed primarily in response to elements of process 300. In particular, SEU 260 may receive a sequence number from an execution thread at 501. The sequence number may be passed with the “set_sequence” command and may be accompanied by a mask and/or an identifier of the execution thread. The identifier may alternatively be determined implicitly from the command itself.

The received sequence number is associated with a mask and a thread identifier at 502. The association may consist of storing these parameters in association with one another in associated memory locations, hardware registers or the like. In a case that the mask was not received at 501, SEU 260 may use the thread identifier as an index to determine the mask from a table of thread identifiers and associated thread masks. In some embodiments, SEU 260 is programmed with programmer-specified thread masks upon initialization. Either of the latter two embodiments may eliminate a need to include thread masks within the parameters of the SEU commands described herein.

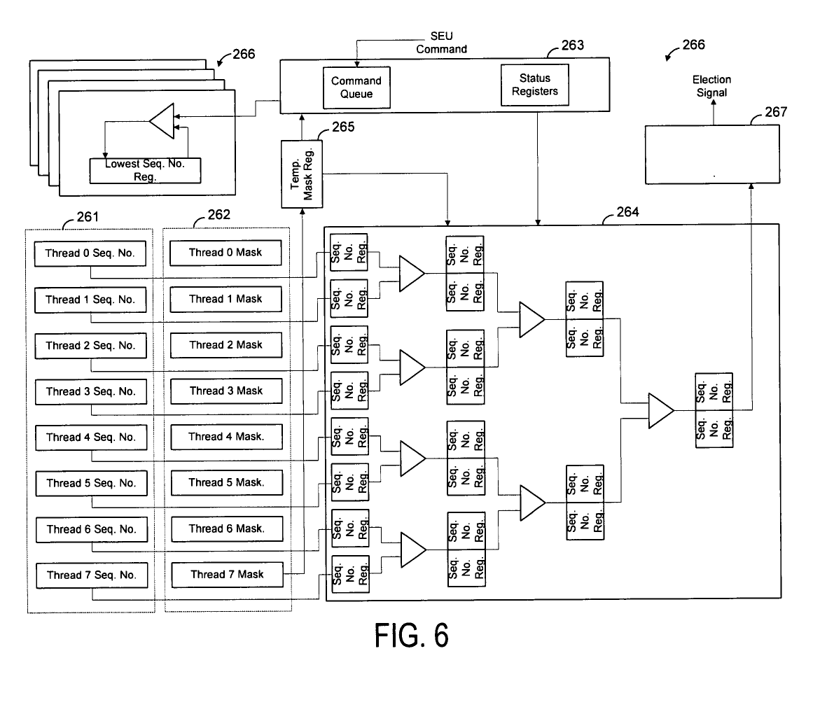

FIG. 6 is a diagram of an implementation of SEU 260 according to some embodiments. The sequence number, thread identifier and thread mask may be associated at 502 by storing data in appropriate ones of thread sequence registers 261 and thread mask registers 262. For example, a thread sequence and thread mask associated with thread 0 may be stored in a first row of thread sequence registers 261 and thread mask registers 262, respectively, in order to associated the thread identifier with the sequence number and thread mask. The storage may proceed under control of SEU control logic 263, which receives the set_sequence command into a command queue and stores the sequence number and mask based thereon.

At 503, the command queue may also receive a request for election from a thread (e.g. a “check_sequence” command) as described with respect to 304. If such a request is received, SEU 260 determines whether the requesting thread is associated with a lowest sequence number of all threads specified by the thread mask that is associated with the thread. In some embodiments, this determination includes identifying any of thread mask registers 262 that include the thread mask of the requesting thread, identifying the sequence numbers stored in the thread sequence registers that are associated with the identified thread mask registers, and determining if the sequence number associated with the requesting thread is the lowest of all the identified sequence numbers.

Comparator unit 264 of SEU 260 may assist in the determination at 504. Comparator unit 264 receives the thread mask associated with the requesting thread from temporary mask register 265 and enables or disables various comparators based on the thread mask. The enabling/disabling allows comparator unit 264 to compare only sequence numbers of threads that are associated with the thread mask of interest. The compared sequence numbers and associated thread identifiers propagate through the comparators and temporary registers of comparator unit 264 until a lowest sequence number and associated thread identifier are determined. In some embodiments, each comparator of comparator unit 264 determines that sequence number A is lower than sequence number B if the expression (in C-language notation) (A<B) && (A!=0xffffffff) && !(((0xc0000000 & A) ==0) && ((0xc0000000 & B) ==0xc0000000)) is true. If not, comparator unit 264 determines that sequence number B is lower than sequence number A.

In some embodiments, SEU 260 includes one or more Lowest Sequence Register (LSR) units 266. The actual number of LSR units 266 may equal the number of significant bits in the thread mask. The one or more LSR units 266 may assist in the determination at 504 by storing a lowest sequence number for each sequence controlled by SEU 260 and by performing one comparison (between the stored sequence number and the sequence number of the requesting thread) in order to determine if the thread is associated with a lowest sequence number.

Flow continues to 505 if the determination of 504 is positive. At 505, the thread identifier, sequence number and thread mask of the requesting thread are designated as the owner of the sequence that is being controlled by SEU 260. Such a designation may consist of storing the thread identifier in a status register of control logic 263. Signal unit 267 receives the thread identifier from comparator unit 264 and, at 506, transmits the election signal described with respect to 305 to the requesting thread. Flow then returns to 503.

If the determination at 504 is negative, the thread is swapped out at 507. In this regard, the requesting thread is put into the sleep state as described above with respect to execution thread 420 and another ready thread begins to execute. 507 may include transmitting a swap-out signal to controller 220 or to a microengine executing the requesting thread. Alternatively, the check _sequence instruction may include a “ctx_swap” token. Flow proceeds to 503 from 507.

If no request for election is received at 503, SEU 260 determines whether an indication of completed processing has been received from a thread at 508. This indication may correspond to the free_sequence command described with respect to 307. Flow returns to 503 if no such indication is received.

If an indication of completed processing was received, SEU 260 disassociates the thread identifier of the thread from which the indication was received from the sequence number of the thread. 509 comprises removing the sequence number from the thread sequence register 261 that is associated with the thread. Due to the disassociation, the thread is no longer associated with a lowest sequence number of all threads associated with its thread mask. Therefore, at 510, an election signal is transmitted to a thread of the associated threads that is now associated with the lowest sequence number. The thread that receives the election signal may thereafter perform the particular processing on its m-packet once it receives the execution context.

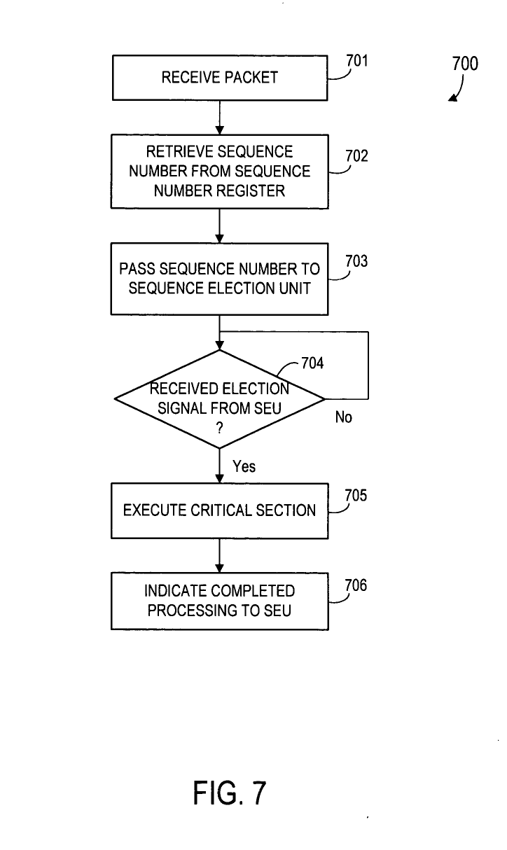

FIG. 7 is a flow diagram of process 700 that may be executed by network device 120 to process a network packet. More particularly, process 700 may be executed by each of a plurality of threads of one or more of microengines 210 through 217 of network processor 200 to perform critical section processing of network packets. Process 700 may be embodied in program code stored in one of the above-described control stores. The program code may be received by a control store from any medium, such as a hard disk, an IC-based memory, a signal, a network connection, or the like. The program code may be included in a Software Developers' Kit associated with network processor 200.

Prior to performing critical section processing on an m-packet, the m-packet may be analyzed to determine an execution thread that should perform the processing. Prior to 701, the m-packet is dequeued to the determined execution thread from a receive ring.

The dequeued m-packet is then received at 701. FIG. 7 is a diagram similar to FIG. 4 to illustrate SEU 260 and execution threads 410, 420 and 430 during one implementation of process 700. M-packet 415 is received from the receive ring at 701 by thread 410.

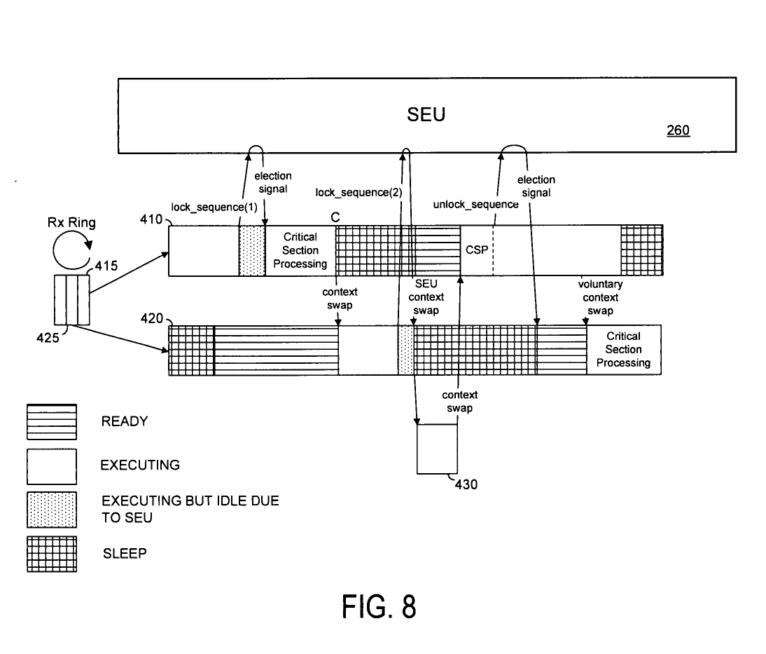

Execution thread 410 retrieves a sequence number from SNR 270 at 702 as described above. The sequence number may then be passed to SEU 260 at 703 as a parameter to the “lock_sequence” command. FIG. 8 shows execution thread passing a sequence number of 1 to SEU 260 at 703. The sequence number is passed in some embodiments along with an identifier of execution thread 410 and a thread mask. Again, the mask allows SEU 260 to determine which of a designated group of threads is associated with a lowest sequence number. Such a determination may enable critical section processing of packets by threads belonging to the group.

Execution thread 410 waits at 704 until it receives an election signal from SEU 260. Transmission of this signal by SEU 260 will be described in detail below with respect to process 900. As shown in FIG. 8, thread 410 remains in the executing state while waiting for the election signal. Thread 410 than executes the critical section at 705 after the election signal is received.

Thread 410 may perform an I/O function during the critical section processing at 705. This function may trigger a context swap at point C of FIG. 8. Accordingly, the execution context is passed to thread 420, which is in the ready state at point C and which is associated with a same thread mask as thread 410. Execution thread 420 executes process 700 in parallel with execution thread 410.

Upon receiving the context, execution thread 420 retrieves a sequence number at 702 and passes the sequence number (2) to SEU 260 at 703 using the lock_sequence command. Execution thread 420 transmits the lock_sequence command because next processing to be performed by thread 420 on m-packet 425 is critical section processing. Again, SEU 260 may store the sequence number in association with a thread identifier and a mask, wherein the mask is identical to the mask that was stored in association with thread 410.

Thread 420 waits in the executing state at 704 while a context swap is performed to pass the context from thread 420 to thread 430. As will be described below, the context swap occurs because thread 420 is not associated with a lowest sequence number in comparison to all other threads that are associated with a same thread mask.

Thread 410 then receives the execution context due to an I/O access or the like performed by thread 430, and finishes executing the critical section at 705. Next, at 706, thread 410 indicates completed processing to SEU 260. This indication may comprise an unlock_sequence command. In response to the command, SEU 260 determines a thread that is associated with a lowest sequence number in comparison to all other threads that are associated with a same thread mask, and transmits an election signal to that thread.

Thread 420 receives the election signal as shown in FIG. 8, and wakes from its sleep state to the ready state in response to the election signal. Execution thread 420 does not immediately begin to execute the critical section after receiving the election signal because execution thread 410 still possesses the execution context at that time. As shown in FIG. 8, execution thread 410 performs a voluntary swap, and execution thread 420 receives the execution context and begins to execute the critical section. Process 700 may, in some embodiments, thereby allow proper critical section processing of received packets.

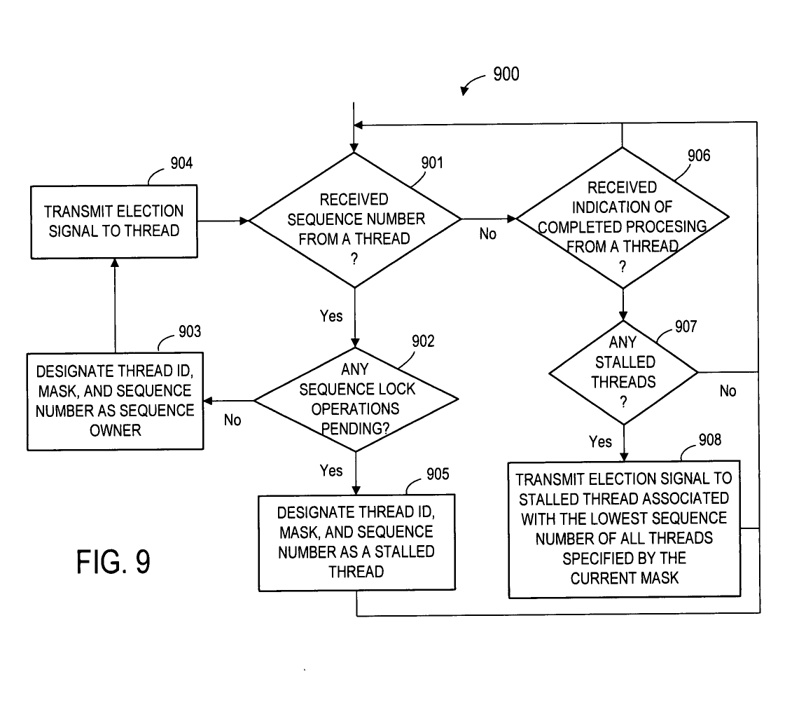

FIG. 9 is a flow diagram of process 900 that may be executed by network device 120 to process a network packet. Process 900 may be executed by SEU 260 in conjunction with the execution of process 700 by one or more execution threads. Process 900 may be embodied in program code stored in one of the above-described control stores and/or may be hardware-implemented.

At 901, SEU 260 determines if it has received a sequence number from an execution thread. The sequence number may be received as a parameter to the lock_sequence command discussed above, and may be received with a mask and/or an identifier of the execution thread. If no mask is received at 501, SEU 260 may use the identifier as an index to determine the mask from a table of thread identifiers and associated thread masks. The lock_sequence command may be received by a command queue of SEU control logic 263, which controls SEU 260 based thereon.

For example, SEU 260 determines if any sequence lock operations are pending at 902 if a sequence number was received in 901. Status registers of control logic 263 may indicate whether any sequence lock operations are pending. For example, the status registers may indicate that a particular thread has previously issued the sequence_lock command and owns the sequence controlled by SEU 260. Flow continues from 902 to 903 f no thread currently owns the sequence.

At 903, the thread identifier, sequence number and thread mask of the thread are designated as the owner of the sequence. Signal unit 267 then transmits the election signal described with respect to 704 to the thread, and flow returns to 901. The thread is then free to exclusively execute the critical section once it receives the execution context.

The thread identifier, sequence number and thread mask of the thread are designated as a stalled thread at 905 if any sequence lock operations are pending at 902. This designation may comprise storing the thread identifier, sequence number and thread mask in a status register of control logic 263 or otherwise flagging the thread as stalled. Usage of this designation will be described with respect to 908. Flow returns to 901 from 905.

Flow continues to 906 if no sequence number is received from a thread at 901. At 906, SEU 260 determines if an indication of completed processing such as the above described lock_sequence command has been received from a thread. If not, flow returns to 901.

If such an indication has been received, SEU 260 determines if any threads are currently designated as stalled at 907. This determination may comprise analyzing the contents of status registers of control logic 263. Flow returns to 901 if no threads are stalled. If one or more threads are designated as stalled, SEU 260 transmits an election signal to a stalled thread at 908. The election signal is transmitted to the stalled thread that is associated with a lowest sequence number of all stalled threads specified by the current mask. Process 900 may therefore provide proper critical section processing by multiple threads.

Some embodiments provide one instance of SEU 260 for each packet processing engine. An SEU in such an embodiment may provide in-order processing and critical section processing for threads of a single packet processing engine. Other embodiments comprise at least one SEU that provides in-order processing and critical section processing for execution threads of two or more packet processing engines. Each of the above solutions may incorporate thread masks to virtually split the SEU into two or more independent control units.

According to some embodiments, two or more instances of SEU 260 are provided for each of one or more packet processing engines. In a case that four SEUs are provided for a single packet processing engine, a functional pipeline assigned to the engine could include four fully independent in-group order stages or critical sections that are processed in parallel. In a case that multiple SEUs are used, each of the above-described commands may include a parameter that identifies an SEU that should process the command.

Some embodiments provide thread mask programming. A 32-bit mask could group every two threads within four eight-threaded packet processing engines. A programmer may, for example, distribute processing over different threads of different engines using known hashing methods. According to one method, a thread identifier is determined based on a lowest three significant bits stored in a table index, and a processing engine is determined using a round-robin algorithm. Other hashing methods may be used to select an SEU. For example, using sixteen SEUs and four packet engines, a next four bits from the table index could be used to specify the SEU. By coupling only the same threads from different packet engines in the sixteen SEUs, the foregoing scenario enables locking of 128 table entries.

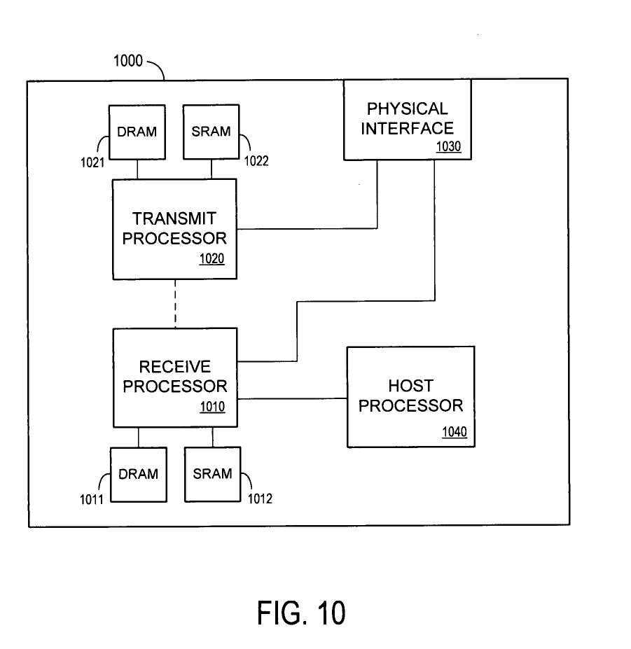

FIG. 10 is a block diagram of a network board according to some embodiments. Network board 1000 may be an element of network device 120 of FIG. 1. Network board 1000 includes transmit processor 1010 and receive processor 1020. One or both of transmit processor 1010 and receive processor 1020 may be implemented by network processor 200 of FIG. 2.

Receive processor 1010 communicates with physical interface 1030 via MSF 250 in order to receive network packets from a remote network device. Receive processor 1010 may process the packets using DRAM 1011 and SRAM 1012. DRAM 1011 and SRAM 1012 may comprise any type of DRAM and SRAM, respectively, including Double Data Rate, Single Data Rate and Quad Data Rate memories. In some embodiments, m-packets representing the received network packets are stored in DRAM 1011 during processing, while metadata associated with the packets is stored in SRAM 1012. Similarly, transmit processor 1020 may transmit network packets to a remote network device using physical interface 1030, which is coupled to MSF 250 of processor 1020. Prior to transmission, the packets may be processed using DRAM 1021 and SRAM 1022.

Host processor 1040 is coupled to receive processor 1010. Host processor 1040 may control the general operation of network board 1000.

The several embodiments described herein are solely for the purpose of illustration. Embodiments may include any currently or hereafter-known versions of the elements described herein. Therefore, persons skilled in the art will recognize from this description that other embodiments may be practiced with various modifications and alterations.

1. A method comprising:
receiving a portion of a network packet;
retrieving a sequence number;
passing the sequence number to a sequence election unit;
waiting to receive a signal to process the packet from the sequence election unit; and
performing processing on the packet in response to receipt of the signal.

2. A method according to claim 1, further comprising:
indicating to the sequence election unit that the processing is complete.

3. A method according to claim 1, wherein the processing must be performed in group order.

4. A method according to claim 1, wherein the processing comprises a critical section of a packet processing pipeline.

5. A method according to claim 1, further comprising:
requesting the signal from the sequence election unit.

6. A method according to claim 1, wherein passing the sequence number further comprises:
passing a mask associated with the sequence number to the sequence election unit.

7. A method according to claim 6, wherein the mask indicates a group of threads designated to perform the processing.

8. A method according to claim 7, wherein the group of threads comprises execution threads of two or more packet processing engines.

9. A medium storing program code, the program code executable to:
receive a portion of a network packet;
retrieve a sequence number;
pass the sequence number to a sequence election unit;
wait to receive a signal to process the packet from the sequence election unit; and
perform processing on the packet in response to receipt of the signal.

10. A medium according to claim 9, wherein the program code executable to pass the sequence number comprises program code executable to:
pass a thread mask associated with the sequence number to the sequence election unit.

11. A medium according to claim 10, wherein the thread mask indicates a group of threads designated to perform the processing.

12. A medium according to claim 11, wherein the group of threads comprises execution threads of two or more packet processing engines.

13. A method comprising:
receiving a sequence number associated with an execution thread;
receiving a request for election from the execution thread;
determining whether the sequence number is less than sequence numbers associated with a respective other one or more execution threads; and
transmitting an election signal to the execution thread if it is determined that the sequence number is less than the sequence numbers associated with the respective other one or more execution threads.

14. A method according to claim 13, further comprising:
associating the sequence number with a mask.

15. A method according to claim 14, wherein the one or more other threads are associated with the mask.

16. A method according to claim 15, wherein the mask indicates a group of threads designated to perform particular processing.

17. A method according to claim 13, further comprising:
receiving an indication of completed processing from the execution thread.

18. A method according to claim 17, further comprising:
determining a second execution thread of the other one or more execution threads that is associated with a second sequence number that is less than sequence numbers associated with each other of the other one or more execution threads; and
transmitting an election signal to the second execution thread.

19. A method according to claim 18, wherein the one or more other threads are associated with a mask.

20. A method according to claim 13, further comprising:
swapping out the thread if it is determined that the sequence number is not less than the sequence numbers associated with the respective other one or more execution threads.

21. A medium storing program code, the program code executable to:
receive a sequence number associated with an execution thread;
receive a request for election from the execution thread;
determine whether the sequence number is less than sequence numbers associated with a respective other one or more execution threads; and
transmit an election signal to the execution thread if it is determined that the sequence number is less than the sequence numbers associated with the respective other one or more execution threads.

22. A medium according to claim 21, the program code further executable to:
receive an indication of completed processing from the execution thread;
determine a second execution thread of the other one or more execution threads that is associated with a second sequence number that is less than sequence numbers associated with each other of the other one or more execution threads; and
transmit an election signal to the second execution thread.

23. A medium according to claim 21, the program code further executable to:
swap out the thread if it is determined that the sequence number is not less than the sequence numbers associated with the respective other one or more execution threads.

24. A method comprising:
receiving a sequence number associated with an execution thread;
determining whether a processing sequence associated with the sequence number is locked; and
transmitting an election signal to the execution thread if it is determined that the processing sequence is not locked.

25. A method according to claim 24, further comprising:
receiving an indication of completed processing from the execution thread.

26. A method according to claim 25, further comprising:
determining a second execution thread of another one or more execution threads that is associated with a second sequence number that is less than sequence numbers associated with each other of the other one or more execution threads; and
transmitting an election signal to the second execution thread.

27. A method according to claim 26, wherein the execution thread and the another one or more threads are associated with a mask.

28. A method according to claim 26, wherein the another one or more threads are designated as stalled threads from which respective sequence numbers were previously received.

29. A method according to claim 24, further comprising:
designating the execution thread as a stalled thread if it is determined that the processing sequence is locked.

30. A method according to claim 24, wherein the processing sequence comprises a critical section of a packet processing pipeline.

31. A medium storing program code, the program code executable to:
receive a sequence number associated with an execution thread;
determine whether a processing sequence associated with the sequence number is locked; and
transmit an election signal to the execution thread if it is determined that the processing sequence is not locked.

32. A medium according to claim 31, the program code further executable to:
receive an indication of completed processing from the execution thread;
determine a second execution thread of another one or more execution threads that is associated with a second sequence number that is less than sequence numbers associated with each other of the other one or more execution threads; and
transmit an election signal to the second execution thread.

33. A device comprising:
a packet processing engine to provide a plurality of execution threads;
a sequence number register to provide a respective sequence number to one or more of the plurality of execution threads; and
a sequence election unit to elect one of the one or more of the plurality of execution threads based on sequence numbers provided to the one or more of the plurality of execution threads.

34. A device according to claim 33, the sequence election unit further to transmit an election signal to the elected one of the one or more of the plurality of execution threads.

35. A device according to claim 33, the sequence election unit further to associate the one or more of the plurality of execution threads with a mask.

36. A device according to claim 35, wherein the mask indicates a group of threads designated to perform particular processing.

37. A device according to claim 33, the sequence election unit further to receive a sequence number associated with an execution thread of the one or more of the plurality of execution threads, to determine whether a processing sequence associated with the sequence number is locked, and to transmit an election signal to the execution thread if it is determined that the processing sequence is not locked.

38. A device according to claim 37, the sequence election unit further to receive an indication of completed processing from the execution thread, to determine a second execution thread of the one or more of the plurality of execution threads that is associated with a second sequence number that is less than sequence numbers associated with each other of the one or more of the plurality of execution threads, and to transmit an election signal to the second execution thread.

39. A device according to claim 33, further comprising a network processor comprising the packet processing engine, the sequence number register, and the sequence election unit.

40. A system according to claim 39, wherein the network processor further comprises two or more packet processing engines.

41. A system comprising:
a packet processing engine to provide a plurality of execution threads;
a sequence number register to provide a respective sequence number to one or more of the plurality of execution threads;
a sequence election unit to elect one of the one or more of the plurality of execution threads based on sequence numbers provided to the one or more of the plurality of execution threads; and
a Double Data Rate memory.

42. A system according to claim 41, further comprising a network processor comprising the packet processing engine, the sequence number register, and the sequence election unit.

43. A system according to claim 42, wherein the network processor further comprises two or more packet processing engines.

44. A system according to claim 41, the sequence election unit further to receive a sequence number associated with an execution thread of the one or more of the plurality of execution threads, to determine whether a processing sequence associated with the sequence number is locked, to transmit an election signal to the execution thread if it is determined that the processing sequence is not locked, to receive an indication of completed processing from the execution thread, to determine a second execution thread of the one or more of the plurality of execution threads that is associated with a second sequence number that is less than sequence numbers associated with each other of the one or more of the plurality of execution threads, and to transmit an election signal to the second execution thread.
